(19) United States
(12) Patent Application Publication
(10) Pub. No.: US 2003/0089148 A1
(43) Pub. Date: May 15, 2003

(54) Lock with pull resistant master cylinder

(76) Inventor: Jiaqiang Ruan, Taishan (CN)

Correspondence Address: Morgan & Finnegan L.L.P, Maria C.H. Lin, 345 Park Avenue, New York, NY, 10154-0053, US

(21) Appl. No.: 10/252,778

(22) Filed: Sep. 23, 2002

(30) Foreign Application Priority Data
Nov. 10, 2001 (CN) 01 2 57963.7

(51) Int. Cl. E05B 25/00; E05B 27/04

(52) U.S. Cl. 70/386; 70/493

(57) ABSTRACT

The present invention is directed to a lock with a master cylinder that is highly resistant to pulling. The lock comprises a lock body 10 with a hole, a master cylinder 20 rotatably mounted within the cylindrical hole of the lock body, and tumbler unit 30 mounted in the master cylinder wherein at least one metal pull resistant element 40 is inserted between the outer surface of the master cylinder and the inner surface of the wall of the cylindrical hole in the lock body. The metal pull resistant element prevents the master cylinder from being pulling out of the lock body in an axial direction. The metal pull resistant element 40 may be a ball, a cylinder or a block inserted 20 and held in place between an indentation 21 provided on the outer surface of master cylinder and an annular concavity provided on the inner wall surface of the cylindrical hole for the master cylinder in the lock body 10 and at a location opposite to the indentation 21. The metal pull resistant element 40 may be inserted via a cylindrical aperture 12 in the wall of the lock body 10. The cylindrical aperture is then sealed with a plug screw 50 after the metal pull resistant element has been inserted. The presence of the metal pull resistant element between the master cylinder and the lock body of the lock of the present invention provides an effective means for providing a high pulling resistance of the master cylinder in an axial direction to enhance lock security.

### FIELD OF THE INVENTION

This invention is directed to a lock with a master cylinder that is highly resistant to being pulled out of the lock body. More particularly, the present invention is directed to a door lock with a master cylinder that is resistant to being pulled out by force from the lock body along the axial direction.

### BACKGROUND OF THE INVENTION

A lock is one of the most commonly applied security devices used in our every day lives. It is employed extensively in buildings, vehicles, and on cases and bags for securing the contents therein. A lock after being secured may only be opened with an appropriate key or a cipher.

Generally, a lock may be in the form of a door lock or a padlock. However, even though locks may appear in different forms, the structures of all locks are very similar. A lock, whether a door lock or a padlock, generally comprises a lock body with a cylindrical hole wherein a master cylinder is rotatably mounted and a tumbler assembly partially mounted in the master cylinder and partially mounted in the lock body. To open the lock, the master cylinder is rotated within the lock body with the turning of an appropriate key co-acting with the tumbler assembly. However, in traditional locks, with no means to prevent the master cylinder from being easily pulled out along the axial direction, the lock can be easily damaged and becomes non-functional in providing security.

In almost all of the countries in the world, there are standards specified for the pulling resistance of a master cylinder and methods for testing such pulling resistance. For example, in the United States of America, the BHMA sets the standards for three different grades of locks: 1100N for the first grade, 4800N for the second grade and 2300N for the third grade. However, in conventional door locks, the above standards are not met.

### SUMMARY OF THE INVENTION

An object of the present invention is to provide a novel lock wherein a structure is placed between the lock body and master cylinder to prevent the master cylinder from being pulled out of the lock body.

A further object of the present invention is to improve the pulling resistance of the master cylinder of a lock to significantly enhance the security provided.

These objectives are achieved in the present invention by providing a lock comprising a lock body 10 with a cylindrical hole 13, a master cylinder 20 rotatably mounted within the cylindrical hole 13 in the lock body 10 and a tumbler assembly 30 mounted in the master cylinder 20 and the lock body 10, wherein at least one metal pull resistant element 40 is inserted between the interior wall of the cylindrical hole 13 and an indentation 21 on the outer surface of the master cylinder. The metal pull resistant element 40 may be in the form of a ball, a block or a cylinder.

Specifically, an indentation 21 is provided on an outer surface of master cylinder 20. An annular groove 11 may be located in the wall of lock body 10 at a location corresponding to the position of indentation 21 on the master cylinder. The pull resistant metal element 40 is inserted through a cylindrical aperture 12 in the wall of the lock body into indentation 21. The metal pull resistant element 40 may be held between the indentation 21 and the annular groove 11. After the metal element 40 has been inserted into indentation 21, the cylindrical aperture 12 is sealed with a plug screw 50.

By providing a metal pull resistant element 40 to hold the master cylinder in the lock body, the pulling resistance of the master cylinder in an axial direction is greatly improved. The presence of the metal pull resistant element between the outer surface of the master cylinder 20 and the interior surface of the wall of the cylindrical hole 13 of the lock body 10 restricts the axial movement of the master cylinder inside the lock body. The increase in pulling resistance can be demonstrated by applying existing methods for testing the pulling resistance of the master cylinder to an axial pulling force. The results obtained in such a test showed that the pulling resistance of the master cylinder of a lock of the present invention is 11000N, far exceeding that specified in the US BHMA Standard for locks. Moreover, the structure provided in the present invention is simple, easy and cheap to apply.

### BRIEF DESCRIPTION OF THE DRAWINGS

FIG. 1 presents a breakdown view of the parts for the lock of the present invention.

FIG. 2 shows a cutaway view for the lock of the present invention.

FIG. 3 shows a standard method for testing the resistance to pulling in a lock.

### DESCRIPTION OF PREFERRED EMBODIMENTS

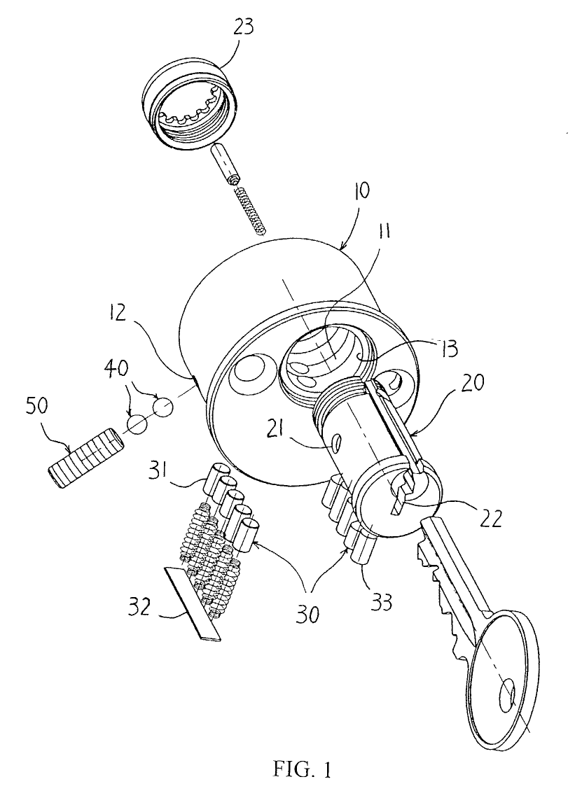

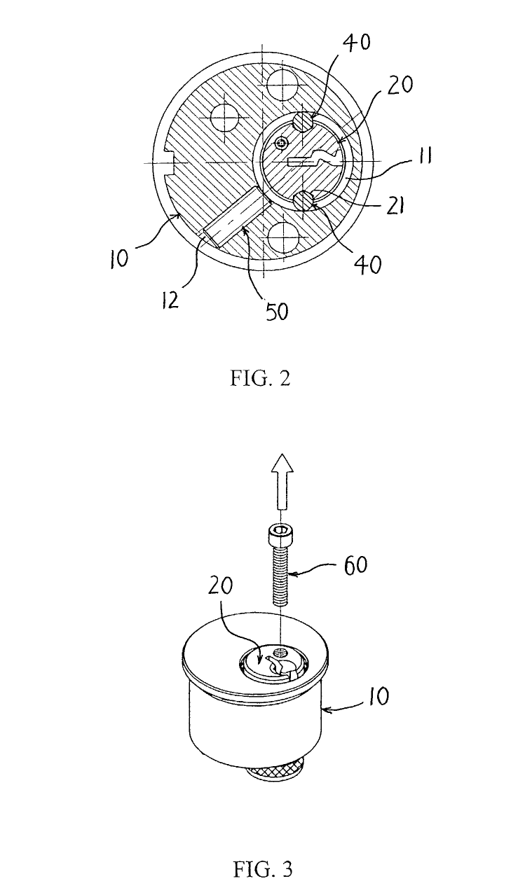

As shown FIG. 1 and FIG. 2, a lock of the present invention with high resistance to pulling out of the master cylinder shares almost the same structure as a conventional door lock, including a lock body 10 with a cylindrical hole 13, a master cylinder 20 rotatably mounted in the cylindrical hole 13, and a tumbler assembly 30 mounted inside the master cylinder and the lock body. A keyhole 22 is located along the central axis of the master cylinder. The lower part of the tumbler assembly 33 is mounted in the master cylinder. The upper part of the tumbler assembly 31 is mounted in the lock body. The master cylinder is held in place in the cylindrical hole 13 by a rear ring cover 23 screwable into a set of screw threads provided on the rear end of the master cylinder. The upper part of the tumbler assembly is held in place in the lock body by a packing sheet 32.

At least one metal pull resistant element 40 is placed between the outer surface of the master cylinder and the inner wall surface of the cylindrical hole 13 in the lock body. The metal pull resistant element 40 may be held between an indentation 21 on the outer surface of the master cylinder and the inner wall surface of the cylindrical hole 13. An annular groove 11 may also be provided on the inner wall surface of the cylindrical hole 13 at a location corresponding to the position of the indentation 21 an the metal pull resistant element 40 may be held between the indentation 21 and the annular groove 11. The presence of the metal pull resistant element 40 ensures that the master cylinder can rotate within cylindrical hole 13 and can not move in an axial direction. Thus, the pulling resistance of the master cylinder of a lock of the present invention is improved. The improvement in pulling resistance is demonstrated by a test shown in FIG. 3. Preferably, two to four metal elements may be inserted between the outer surface of the master cylinder 20 and the interior wall of the cylindrical hole. FIG. 2 shows one embodiment wherein of two metal pull resistant elements are inserted. Preferably, the two metal elements are placed symmetrically on opposite sides of the master cylinder and in the central portion of the master cylinder along the axial direction. The metal pull resistant element 40 may be a ball, a cylinder, or a block or other suitable shape. Based on the angle of stress placed on the metal pull resistant element, preferably it is a ball. Most preferably, the metal element is a steel ball.

To allow the metal pull resistant element to function without affecting the rotation of the master cylinder within the lock body, the indentation 21 for the insertion of the metal pull resistant element 40 is located on the outer surface of master cylinder 20 in the central portion thereof along its axis in a position that does not interfere with the tumbler assembly. In a preferred embodiment as illustrated in FIG. 2, each of the indentations 21 is hemispherical. A part of a steel ball is inserted into the indentation. At a location opposite the indentation 21, an annular groove 11 is provided on the interior surface of the wall of the cylindrical hole in the lock body 10. The metal pull resistant element 40 is held between the annular groove 11 and the indentation 21. After the metal pull resistant element 40 is inserted through the cylindrical aperture 12 in the wall of the lock body 10, the cylindrical aperture is sealed with a plug screw 50.

FIG. 3 shows a method by which the pulling resistance of a master cylinder was tested. First, a bolt is fastened to the master cylinder along the axial direction. Second, a outward pulling force is applied to the master cylinder through the bolt until the master cylinder is disconnected from the lock body. The pulling force is applied by the use of a machine for testing tensile strength. With this test, the pulling resistance of a door lock of the present invention reached 11000N or above, significantly higher than that specified for the highest grade for locks under the US BHMA Standard.

What is claimed 1 is:

1. A lock with a master cylinder with high pulling resistance, comprising a lock body having a cylindrical hole therethrough, a master cylinder rotatably mounted within the cylindrical hole, and a tumbler assembly 30 partially mounted within the master cylinder and partially mounted in the lock body, wherein at least one metal pull resistant element is inserted between the interior wall surface of the cylindrical hole in the lock body and an indentation on the outer surface of the master cylinder to prevent the master cylinder from being pulled out of the lock body the axial direction of the master cylinder.

2. A lock according to claim 1 wherein the metal pull resistant element is a ball, a cylinder or a block.

3. A lock according to claim 1 wherein the metal pull resistant element is inserted and held in place between an indentation provided on the outer surface of master cylinder and an annular groove on the inner wall surface of the cylindrical hole in lock body 10 at a location opposite to the indentation.

4. A method for inserting a metal element into a door lock according any one of claims 1, 2, or 3, wherein the metal pull resistant element is inserted via a cylindrical aperture in the wall of the lock body, the cylindrical aperture being subsequently sealed with a plug screw.
